(19) United States
(12) Patent Application Publication
(10) Pub. No.: US 2026/0346670 A1
(43) Pub. Date: Nov. 5, 2026

(54) Jounce Bumper Assemblies for High Angular Impact as well as Gas Spring Assemblies and Suspension Systems Including Same

(71) Applicant: Firestone Industrial Products Company, LLC, Nashville, TN (US)

(72) Inventors: Gabriel V. ONITA, Arnhem (NL); Suhale MANZOOR, Lebanon, TN (US)

(21) Appl. No.: 19/482,742

(22) PCT Filed: May 10, 2024
(86) PCT No.: PCT/US2024/029000

§ 371 Date: Nov. 8, 2025

Related U.S. Application Data
(60) Provisional application No. 63/501,362, filed on May 10, 2023.

(51) Int. Cl. B60G 15/08; F16F 9/05; F16F 9/32

(52) U.S. Cl. CPC B60G 15/08; F16F 9/055; F16F 9/3207; B60G 2202/152

(57) ABSTRACT

Jounce bumper (288) and end closure assemblies (290) include USC a jounce bumper (288) formed from elastomeric material and supported within a bumper-restraining recess (316) of an end closure (290). The end closure (290) includes an inner side wall (314) that defines the bumper-restraining recess (316). The assemblies include a combination of the elastomeric material compliance from the elastomeric material and a progressive geometry of the inner side wall (314) of the end closure (290) that result in the jounce bumper (288) WVS being operable to withstand high angular impacts and compressive loads associated with jounce conditions of gas spring assemblies. Gas spring assemblies (124; 138; 200) including such jounce bumper (288) and end closure assemblies (290) as well as suspension systems including one of more of such gas spring assemblies (124; 138; 200) are also included.

### BACKGROUND

The subject matter of the present disclosure broadly relates to the art of gas spring devices and, more particularly, to jounce bumper assemblies supported on or along one of two opposing end members of a gas spring assembly. Innovative jounce bumper assemblies according to the present disclosure include an end closure with an integral bumper restraining recess that receives a portion of a jounce bumper body. The integral bumper restraining recess is operable to restrict or at least partially restrain radially-outward expansion of the jounce bumper body during high angular impacts and compressive loads associated with jounce conditions. Gas spring assemblies including such jounce bumper assemblies as well as suspension systems that include one or more of such gas spring assemblies are also included.

The subject matter of the present disclosure may find particular application and use in conjunction with components for wheeled vehicles, and will be shown and described herein with reference thereto. However, it is to be appreciated that the subject matter of the present disclosure is also amenable to use in other applications and environments, and that the specific uses shown and described herein are merely exemplary. For example, the subject matter of the present disclosure could be used in connection with gas spring assemblies of non-wheeled vehicles, support structures, height adjusting systems and actuators associated with industrial machinery, components thereof and/or other such equipment. Accordingly, the subject matter of the present disclosure is not intended to be limited to use associated with gas spring suspension systems of wheeled vehicles.

Wheeled motor vehicles of most types and kinds include a sprung mass, such as a body or chassis, for example, and an unsprung mass, such as two or more axles or other wheel-engaging members, for example, with a suspension system disposed therebetween. Typically, a suspension system will include a plurality of spring devices as well as a plurality of damping devices that together permit the sprung and unsprung masses of the vehicle to move in a somewhat controlled manner relative to one another. Movement of the sprung and unsprung masses toward one another is normally referred to in the art as jounce motion while movement of the sprung and unsprung masses away from one another is commonly referred to in the art as rebound motion.

It will be appreciated that vehicle suspension systems of a wide variety of types and kinds have been developed and are commonly used. Components of such vehicle suspension systems are often secured between opposing structural members that move relative to one another during travel between jounce and rebound conditions. In some cases, the spring devices can take the form of gas spring assemblies that utilize pressurized gas as the working medium. Gas spring assemblies of various types, kinds and constructions are well known and commonly used. Typical gas spring assemblies can include a flexible wall that is secured between comparatively rigid end members and/or end member assemblies.

To eliminate contact between opposing portions of the sprung and unsprung masses, contact between opposing portions of components of the suspension system or contact between any combination thereof, jounce bumpers are commonly installed on one or more portions of the vehicle to prevent such opposing portions from directly impacting or otherwise directly contacting one another. Thus, during full jounce conditions of a suspension system, an opposing component will contact the jounce bumper rather than impacting the component on or near which the jounce bumper is mounted.

Jounce bumpers of a variety of types, kinds and configurations have been developed and are commonly used. Though the size and shape of jounce bumpers vary widely, known jounce bumpers can generally be grouped into two categories, namely, compliant jounce bumpers and rigid jounce bumpers. The former are commonly formed from materials capable of relatively high deflections under load, and are often formed from rubber or elastomeric foam compounds. Generally, compliant jounce bumpers act to cushion or soften the impact that would otherwise be associated with a sudden movement toward a full jounce condition. As such, compliant jounce bumpers are commonly deemed to be well suited for use in relatively light duty applications, such as use in the suspension systems of passenger vehicles and light trucks, for example, where ride comfort is a more significant factor. Also, the high axial deflections that would be associated with heavily loading a compliant jounce bumper, such as during use in a commercial truck or other heavy-duty vehicle, would generate high corresponding lateral (e.g., radial) strains in the jounce bumper. Generally, materials that are well suited for comfortably cushioning impacts under full jounce conditions have been found to be poorly suited to such corresponding high levels of lateral strain, which can undesirably modify the performance characteristics of the compliant jounce bumper or even result in permanent deformation of the same.

Additionally, the materials from which known compliant jounce bumpers are typically constructed can range from elastomeric compositions that are harder and more stiff to elastomeric compositions that are softer and more compliant. In some applications, the use of elastomeric compositions that are harder and more stiff can provide certain beneficial performance characteristics, such as a beneficial balance between axial deflection and jounce bumper size (e.g., external dimensions and/or volume). However, in some applications and/or conditions of use, harder and more stiff elastomeric compositions can undergo degradation in durability, particularly over an extended period of use. While jounce bumpers made from softer, more-compliant compositions can exhibit improved durability under such applications and/or conditions of use, such constructions can exhibit less desirable performance and/or physical characteristics associated with the combination of jounce bumper size and axial deflection.

Oppositely, rigid jounce bumpers are commonly formed from materials that deflect a relatively small amount under load, such as high strength and/or fiber reinforced plastic materials, for example. Rigid jounce bumpers are not normally considered to be well suited for use in light duty applications (e.g., passenger vehicle applications) because of the minimal deflection and high impact associated with the use of such jounce bumpers. However, rigid jounce bumpers are commonly deemed to be well suited for heavy duty applications, such as in commercial truck, tractor-trailer and other over-the-road vehicle applications, for example, where it is desirable to provide a sacrificial component that can prevent impacts between more permanent and/or expensive components. In some cases, it may be desirable to lower commercial trucks, trailers or other vehicle bodies onto the jounce bumpers to provide a solid foundation for loading and/or unloading of the vehicle body. While high-speed impacts acting on the jounce bumper are typically not an issue in such dock-height applications, substantial loads are still commonly involved. As discussed above, compliant jounce bumpers are normally formed from materials that are less-well suited for withstanding the loads associated with such heavy duty applications. As such, rigid jounce bumpers are commonly used.

U.S. Pat. No. 3,475,015 discloses a gas spring assembly that includes an end closure used to secure the end of a flexible spring member on or along a piston. A jounce bumper is permanently attached to a side of the end closure opposite the piston. The end closure includes wall contours that extend outwardly beyond the jounce bumper and engage the end of the flexible spring member. However, the contours extend axially only a distance sufficient to receive the end of the flexible spring member. As such, the contours of the end closure are insufficient to provide radial support and corresponding geometric rigidity to the jounce bumper, particularly under impacts and/or loads imparted on the jounce bumper at an acute angle.

U.S. Pat. No. 7,896,320 discloses a gas spring assembly that includes a jounce bumper and bumper restraining cup combination that is used with a conventional end closure. The bumper restraining cup is an additional part that adds cost and complexity to the construction. Additionally, the bumper restraining cup has a distal edge that can limit axial deflection of the jounce bumper, particularly under impacts and/or loads imparted on the jounce bumper at an acute angle. In some cases, the distal edge of the bumper restraining cup could result in shearing or severing of portions of the jounce bumper that are deflected outward beyond the distal edge of the bumper restraining cup.

Notwithstanding the common use and overall success of known jounce bumpers, it is believed desirable to develop constructions for use in connection with gas spring assemblies and/or components thereof that are capable of providing improved performance or other characteristics and/or overcoming disadvantages of known constructions while promoting relatively low costs of manufacture, ease of assembly and/or otherwise advancing the art of gas spring devices.

### BRIEF DESCRIPTION

One example of a jounce bumper and end closure system in accordance with the subject matter of the present disclosure can include a jounce bumper at least partially formed from elastomeric material. The jounce bumper can have a longitudinal axis and can include a first end surface portion oriented transverse to the longitudinal axis. A second end surface portion can face opposite the first end surface portion. An outer peripheral side surface portion can extend peripherally around the longitudinal axis between the first and second end surface portions. An end closure can include an end closure wall. The end closure wall can include a base wall portion oriented transverse to the longitudinal axis and an inner side wall portion extending axially from along the base wall portion. The base wall portion and the inner side wall portion can at least partially define a bumper receiving recess dimensioned to receive at least the first end surface portion of the jounce bumper against the base wall portion of the end closure. The second end surface portion can project axially beyond the end closure wall. The outer peripheral side surface portion of the jounce bumper can be disposed in facing relation to the inner side wall portion of the end closure. Upon compression of the jounce bumper from along the second end surface portion toward the base wall portion, the inner side wall portion of the end closure can generate progressive geometric rigidity within the jounce bumper.

Another example of a jounce bumper and end closure system in accordance with the subject matter of the present disclosure can include a jounce bumper at least partially formed from elastomeric material. The jounce bumper can have a longitudinal axis and can include a first end surface portion oriented transverse to the longitudinal axis. A second end surface portion can face opposite the first end surface portion. An outer peripheral side surface portion can extend peripherally around the longitudinal axis between the first and second end surface portions. An end closure can include an end closure wall. The end closure wall can include a base wall portion oriented transverse to the longitudinal axis and an inner side wall portion extending axially from along the base wall portion. The base wall portion and the inner side wall portion can at least partially define a bumper receiving recess dimensioned to receive at least the first end surface portion of the jounce bumper against the base wall portion of the end closure with the second end surface portion projecting axially beyond the end closure wall. The outer peripheral side surface portion of the jounce bumper can be disposed in facing relation to the inner side wall portion of the end closure. The jounce bumper being capable of withstanding a transient impact of at least 1000 J at an angular articulation of at least 5 degrees while simultaneously exhibiting a quasistatic load capacity of at least 1000 kN at 30 mm of axial deflection under exposure to a temperature of less than negative 30 degrees Celsius due to a combination of compliance of the elastomeric material of the jounce bumper and progressive geometric rigidity within the jounce bumper generated by the inner side wall portion of the end closure.

One example of a gas spring assembly in accordance with the subject matter of the present disclosure can include a flexible spring member having a longitudinal axis and extending peripherally about the longitudinal axis between first and second ends. The flexible spring member can at least partially define a spring chamber. A first end member can be secured across the first end of the flexible spring member. A second end member can be secured across the second end of the flexible spring member. A jounce bumper and end closure system according to either one of the two foregoing paragraphs can be disposed within the spring chamber and secured on or along one of the first and second end members.

One example of a suspension system in accordance with the subject matter of the present disclosure can include a pressurized gas system including a pressurized gas source and a control device in fluid communication with the pressurized gas source. At least one gas spring assembly in accordance with either one of the foregoing paragraphs can be disposed in fluid communication with the pressurized gas source through the control device.

### BRIEF DESCRIPTION OF THE DRAWINGS

FIG. 1 is a graphical representation of one example of a vehicle including a suspension system in accordance with the subject matter of the present disclosure.

FIG. 2 is a schematic representation of the exemplary vehicle in FIG. 1 including an exemplary suspension system with a plurality of gas spring assemblies in accordance with the subject matter of the present disclosure.

FIG. 3 is a side view of a portion of the suspension system in FIGS. 1 and 2 illustrating a gas spring assembly in accordance with the subject matter of the present disclosure in an installed condition and undergoing displacement.

FIG. 4 is a side view of one example of a gas spring assembly in accordance with the subject matter of the present disclosure, such as is illustrated in FIGS. 2 and 3, for example.

FIG. 5 is a cross-sectional side view of the exemplary gas spring assembly in FIGS. 2-4 taken from along line 5 -5 in FIG. 4.

FIG. 6 is a cross-sectional view of an enlarged portion of the exemplary gas spring assembly in FIGS. 2-5 identified as Detail 6 in FIG. 5.

FIG. 7 a cross-sectional side view of the exemplary gas spring assembly in FIGS. 2-6 shown in a compressed (or jounce) condition with the jounce bumper undergoing a high angular impact in accordance with the subject matter of the present disclosure.

FIG. 8 is a cross-sectional side view of the enlarged portion of the exemplary gas spring assembly in the compressed condition of FIG. 7 identified as Detail 8 therein.

FIG. 9 is a cross-sectional side view of the exemplary end closure shown in FIGS. 5-8.

FIG. 10 is a graphical representation of force verses deflection thresholds for a jounce bumper and end closure system in accordance with the subject matter of the present disclosure.

FIG. 11 is schematic representation of exemplary conditions for simulating high-angle impact conditions experienced by a jounce bumper and end closure system in accordance with the subject matter of the present disclosure.

FIGS. 12-14 sequentially illustrate a jounce bumper and end closure system in accordance with the subject matter of the present disclosure undergoing impact and deflection events to associated with high-angle impact test conditions.

### DETAILED DESCRIPTION

Turning now to the drawings, it is to be understood that the showings are for purposes of illustrating examples of the subject matter of the present disclosure and that the examples shown and described herein are not intended to be limiting. Additionally, it will be appreciated that the drawings are not to scale and that portions of certain features and/or elements may be exaggerated for purpose of clarity and/or ease of understanding.

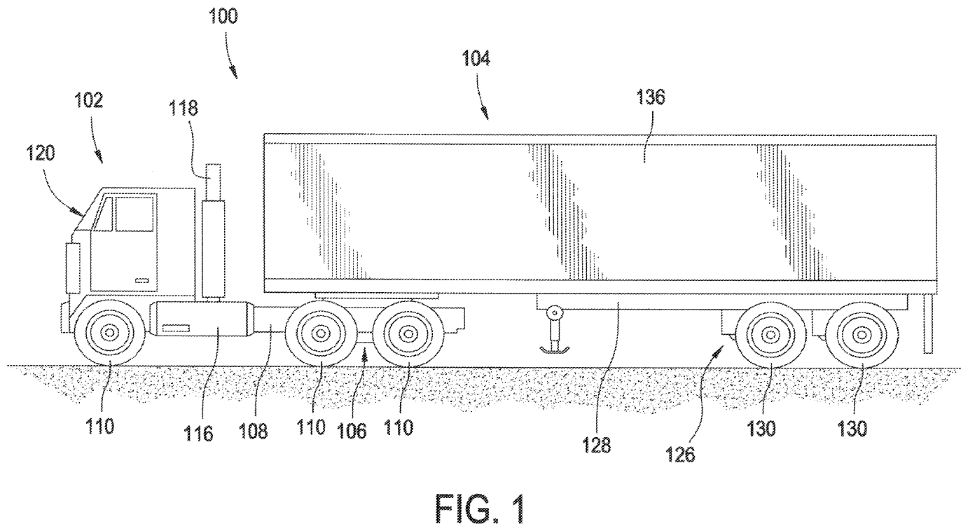

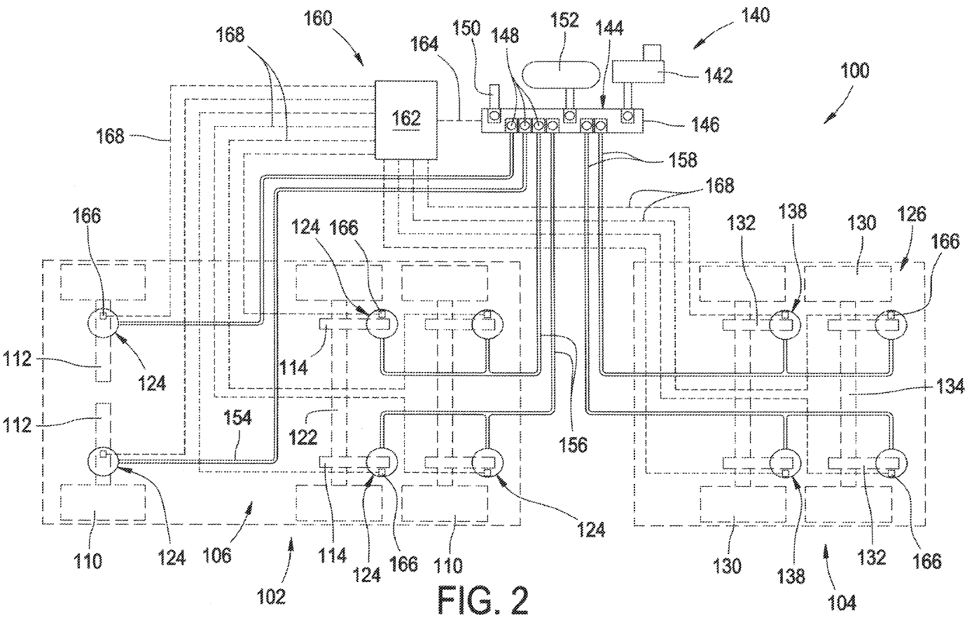

For purposes of illustration and without operating as a limitation, one example of a vehicle that could experience conditions of use in operation under which one or more gas spring assemblies can be displaced sufficiently to generate a high-angular impact of a jounce bumper in accordance with the subject matter of the present disclosure is represented in FIGS. 1 and 2 by vehicle 100. Again, merely for purposes of illustration and explanation and without operating as a limitation, vehicle 100 is shown as taking the form of a tractor-trailer combination that includes an over-the-road tractor 102 and a trailer 104 that is operatively connected to the tractor for over-the-road transport.

Tractor 102 can include a tractor suspension system 106 operatively connected between a sprung mass, such as a frame 108, for example, and an unsprung mass, such as one or more wheels 110, one or more suspension components 112 and/or one or more suspension components 114, for example. Tractor 102 will typically also include an internal combustion engine (not shown) and drivetrain (not shown) that are supported on the frame and provide motive power to one or more of wheels 110. Tractor 102 can include a fuel tank 116 and an exhaust stack 118 that are operatively associated with the engine in an otherwise conventional manner. Tractor 102 can also include an operator compartment or cab 120 that can be supported on or along frame 108 in any suitable manner, such as by way of one or more cab mounts and/or one or more cab suspensions.

It will be appreciated that tractor suspension system 106 can include any suitable combination and/or configuration of suspension components operatively connected between the sprung and unsprung masses of tractor 102. For example, suspension components 112 can be operatively connected between frame 108 (and/or other structural components of tractor 102) and the front or steering wheels of tractor 102. Additionally, or in the alternative, suspension components 114 can be operatively connected between frame 108 (and/or other structural components of tractor 102) and the rear or drive wheels of tractor 102. In some cases, suspension components 112 and/or 114 can be operatively connected with one another through additional suspension components and/or other unsprung masses, such as are represented by suspension components 122 (e.g., axle tubes) operatively interconnecting adjacent ones of suspension components 114, for example.

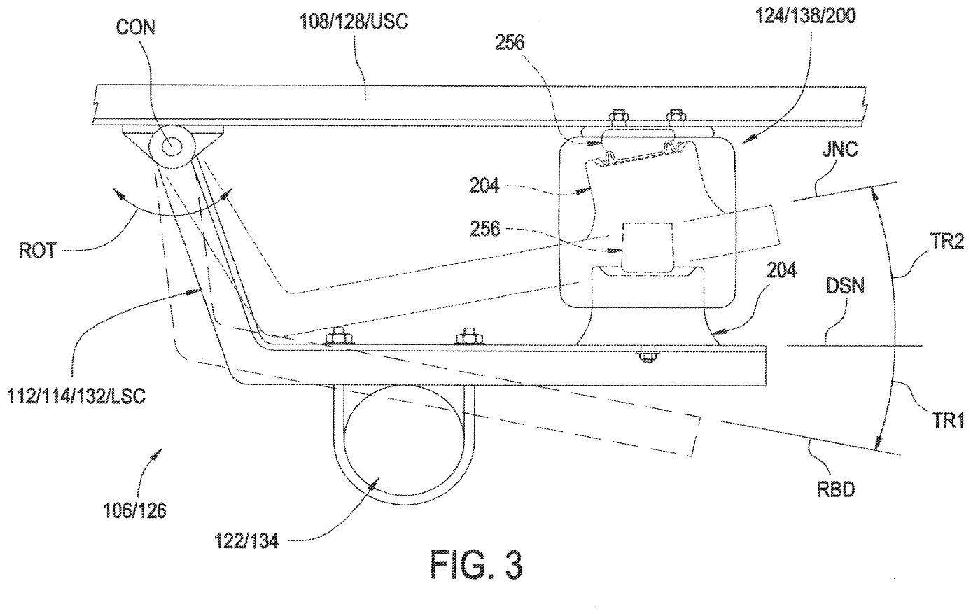

As shown in FIGS. 2 and 3, tractor suspension system 110 also includes one or more gas spring assemblies 124 in accordance with the subject matter of the present disclosure operatively disposed between the sprung and unsprung masses of tractor 102. For example, gas spring assemblies 124 can be operatively disposed between frame 108 (and/or other structural components of tractor 102) and suspension components 112 and/or 114. Additionally, it will be appreciated that tractor suspension system 110 can include any number of one or more systems, components and/or devices, and that the same can be operatively connected between the sprung and unsprung masses of the associated vehicle in any suitable manner. For example, such suspension systems can include a plurality of damping members (not shown), which can be operatively connected between the sprung and unsprung masses of the associated vehicle in any suitable manner.

Trailer 104 includes a trailer suspension system 126 operatively connected between a sprung mass, such as a frame 128, for example, and an unsprung mass, such as one or more wheels 130 and/or one or more suspension components 132, for example. In some cases, suspension components 132 can be operatively connected with one another through additional suspension components and/or other unsprung masses, such as are represented by suspension components 134 (e.g., axle tubes) operatively interconnecting adjacent ones of suspension components 132, for example. Trailer 104 can be adapted for operative connection and disconnection to tractor 102. Trailer 104 can also include a trailer body 136 that is at least partially supported on frame 128 and is generally dimensioned to receive and retain a quantity of cargo.

It will be appreciated that trailer suspension system 126 can include any suitable combination and/or configuration of suspension components operatively connected between the sprung and unsprung masses of trailer 104. For example, suspension components 132 can be operatively connected between frame 128 (and/or other structural components of trailer 104) and the trailing or free-rolling wheels of trailer 104. As shown in FIGS. 2 and 3, trailer suspension system 126 also includes one or more gas spring assemblies 138 in accordance with the subject matter of the present disclosure operatively disposed between the sprung and unsprung masses of trailer 104. For example, gas spring assemblies 138 can be operatively disposed between frame 128 (and/or other structural components of trailer 104) and suspension components 132 and/or 134. Additionally, it will be appreciated that trailer suspension system 126 can include any number of one or more systems, components and/or devices, and that the same can be operatively connected between the sprung and unsprung masses of the associated vehicle in any suitable manner. For example, such suspension systems can include a plurality of damping members (not shown), which can be operatively connected between the sprung and unsprung masses of the associated vehicle in any suitable manner.

It will be appreciated that gas spring assemblies 124 and/or 138 along with numerous components and/or systems of vehicle 100 can utilize pressurized gas (e.g., air) as a working fluid and/or power source for the operation thereof. One greatly-simplified example of a pressurized gas system 140 that is suitable for such use and/or operation is shown in FIG. 2. It will be appreciated that pressurized gas system 140 can be operatively associated with one or more components and/or systems of the vehicle in any suitable manner for selectively supplying pressurized gas (e.g., air) thereto and selectively transferring pressurized gas therefrom. As non-limiting examples, such components and/or systems with which pressurized gas system 140 can be operatively connected can include any combination of any one or more of tractor suspension system 106, a tractor braking system, a cab suspension, trailer suspension system 126 and/or a trailer braking system.

Again, as a non-limiting example, pressurized gas system 140 is shown in FIG. 2 in operative communication with tractor suspension system 106 and trailer suspension system 126. It is to be recognized and understood, however, that such disclosure is merely exemplary and is not intended to be limiting. As such, it is to be recognized and understood that pressurized gas system 140 can be operatively connected with tractor suspension system 106 alone, trailer suspension system 126 alone, both the tractor suspension system and the trailer suspension system, and/or any of the other exemplary components and/or systems of vehicle 100 either individually or in any combination, such as have been discussed above, for example.

In the exemplary embodiment shown in FIG. 2, pressurized gas system 140 includes a pressurized gas source 142, such as a compressor, for example, for generating pressurized air or other gases. A control device 144, such as a valve assembly, for example, is shown as being in communication with pressurized gas source 142 and can be of any suitable configuration or arrangement. In the exemplary embodiment shown, control device 144 can include a valve assembly with a valve block 146 and a plurality of valves 148 supported thereon. Control device 144 can also, optionally, include a suitable exhaust 150, such as a muffler, for example, for venting pressurized gas from the system. Pressurized gas system 140 can also, optionally, include a reservoir 152, which is shown as being in fluid communication with the pressurized gas source and/or the control device, and is suitable for storing pressurized gas at an elevated pressure for an extended period of time, such as minutes, hours, days, weeks or months.

In the exemplary arrangement shown in FIG. 2, pressurized gas system 140 includes gas transfer lines 154 disposed in fluid communication between control device 144 and gas spring assemblies 124 operatively connected with suspension components 112. Additionally, or in the alternative, pressurized gas system 140 can include gas transfer lines 156 disposed in fluid communication between control device 144 and gas spring assemblies 124 operatively connected with suspension components 114. Furthermore, or as another alterative, pressurized gas system 140 can include gas transfer lines 158 disposed in fluid communication between control device 144 and gas spring assemblies 138 operatively connected with suspension components 132. In such arrangements, pressurized gas can be selectively transferred into and/or out of any one or more of gas spring assemblies 124 and/or 138 through control device 144, such as by selectively operating valves 148, for example. Pressurized gas system 140 can also be operatively associated with one or more other components and/or systems, such as has been described above, for example.

As indicated above, it will be appreciated that pressurized gas system 140 is greatly simplified and merely illustrates one example of a pressurized gas system with which gas spring assemblies in accordance with the subject matter of the present disclosure can be used. As such, it will be appreciated that the pressurized gas system can include any one or more additional systems and/or components. For example, in some cases, pressurized gas system 140 can include a control system 160 that is capable of communication with any one or more systems and/or components of vehicle 100, such as for selective operation and/or control thereof. Control system 160 can include a controller or electronic control unit (ECU) 162 communicatively coupled with pressurized gas source 142 and/or control device 144, such as through a conductor or lead 164, for example, for selective operation and control thereof, which can include supplying and exhausting pressurized gas to and/or from any one or more of gas spring assemblies 124 and/or 138 of suspension systems 106 and/or 126, for example. It will be appreciated that controller 162 can be of any suitable type, kind and/or configuration.

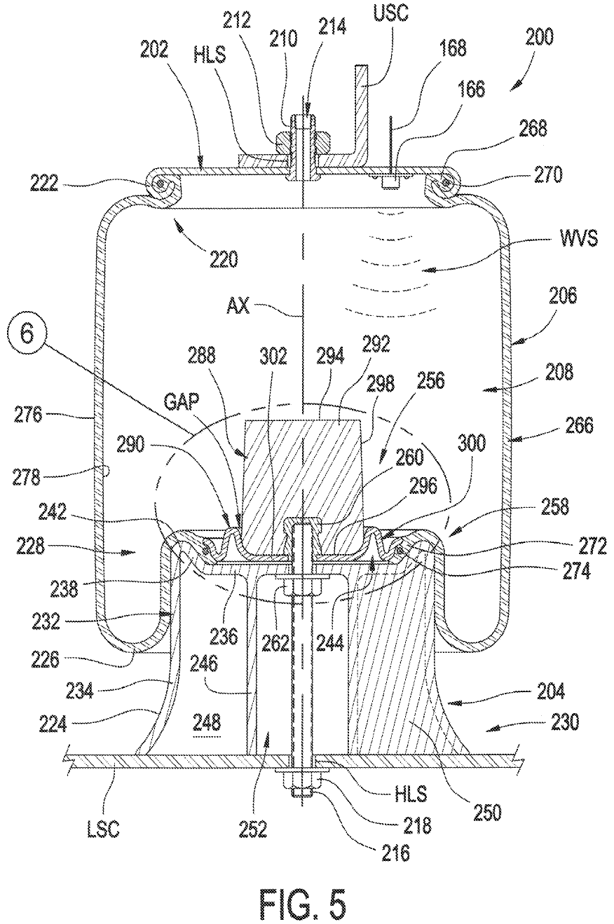

Control system 160 can also optionally include one or more height or distance sensing devices 166 as well as any other desired systems and/or components. Height sensors 166, if included, can be communicatively coupled with controller 162 in any suitable manner, such as by way of conductors or leads 168, for example. If included, the height sensing devices can be capable of generating or otherwise outputting a signal having a relation to a height or distance, such as between spaced components of the vehicle, for example. It will be appreciated that any such optional height sensors or any other distance-determining devices, if provided, can be of any suitable type, kind, construction and/or configuration, such as mechanical linkage sensors, ultrasonic wave sensors or electromagnetic wave sensors, such as may operate using ultrasonic or electromagnetic waves WVS (FIG. 5), for example.

It will be appreciated that gas spring assemblies in accordance with the subject matter of the present disclosure (e.g., gas spring assemblies 124 and/or 138) can find particular application and use in connection with suspension systems that include suspension components (e.g., suspension components 112, 114, and/or 132) that are pivotally attached to the associated sprung mass (e.g., frame 108 and/or 128). In such arrangements, the suspension components a connection or joint that permits at least a portion of the suspension components to pivot, rotate or otherwise move through and/or otherwise along a curvilinear, rotational, arcuate, angular or other non-linear path relative to the sprung mass (e.g., frame 108 and/or 128). One example of a type and kind of known suspension system that is commonly used and includes suspension components operatively connected in such a manner is sometimes referred to in the art as a trailing arm suspension. It is to be recognized and distinctly understood, however, that the subject matter of the present disclosure is merely exemplary and not intended to be limit to application and/or use in association with suspension systems of such types and/or kinds, and that other suitable arrangements and/or configurations could alternately be used.

FIG. 3 illustrates an exemplary arrangement in which a gas spring assembly (e.g., one of gas spring assemblies 124 and/or 138) is operatively disposed between a frame or frame member (e.g., frame 108 and/or 128) and a suspension component (e.g., one of suspension components 112, 114 and/or 132). The suspension component is displaced during use between an extended or rebound condition, which is represented in FIG. 3 by reference characters RBD, and a compressed or jounce condition, which is represented in FIG. 3 by reference characters JNC. It will be appreciated, that the movement of the components of the sprung and unsprung masses relative to one another, as described above, can be due to variations in load conditions and/or result from road inputs and/or other impact conditions (e.g., jounce conditions), as is well understood by those of skill in the art. Additionally, as discussed above, it will be recognized and appreciated that the gas spring assembly and/or components thereof will typically move relative to one another through a curvilinear, rotational, arcuate, angular or other non-linear manner, such as is discussed in additional detail hereinafter.

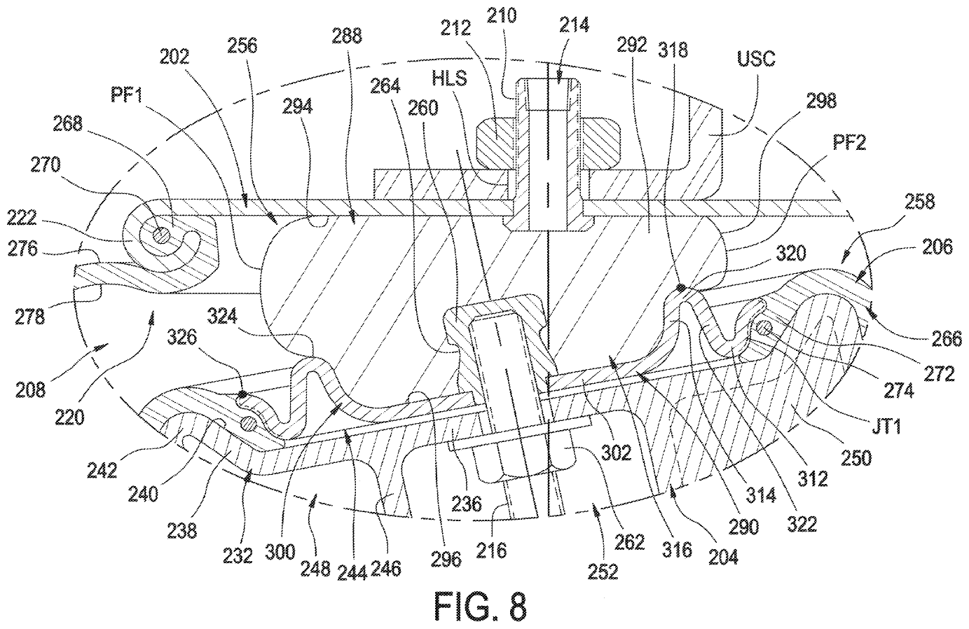

In such an arrangement, the gas spring assembly (e.g., one of gas spring assemblies 124 and/or 138) is disposed at a nominal or design height corresponding to an approximately normal condition of use, such as is represented by reference characters DSN. As the suspension component pivots or otherwise rotates from design height DSN about a joint or connection CON, as is represented by a rotation arrow ROT, in a direction toward rebound condition RBD, as is represented by a travel arrow TR1, the gas spring assembly is extended in an otherwise conventional manner between the frame and the suspension component. As the suspension component pivots or otherwise rotates from design height DSN about connection CON in a direction toward jounce condition JNC, as is represented by a travel arrow TR2, the gas spring assembly is compressed toward and can, in some cases, be displaced sufficiently to generate a high-angular impact of a jounce bumper in accordance with the subject matter of the present disclosure, such as is represented in FIGS. 3, 7 and 8, for example.

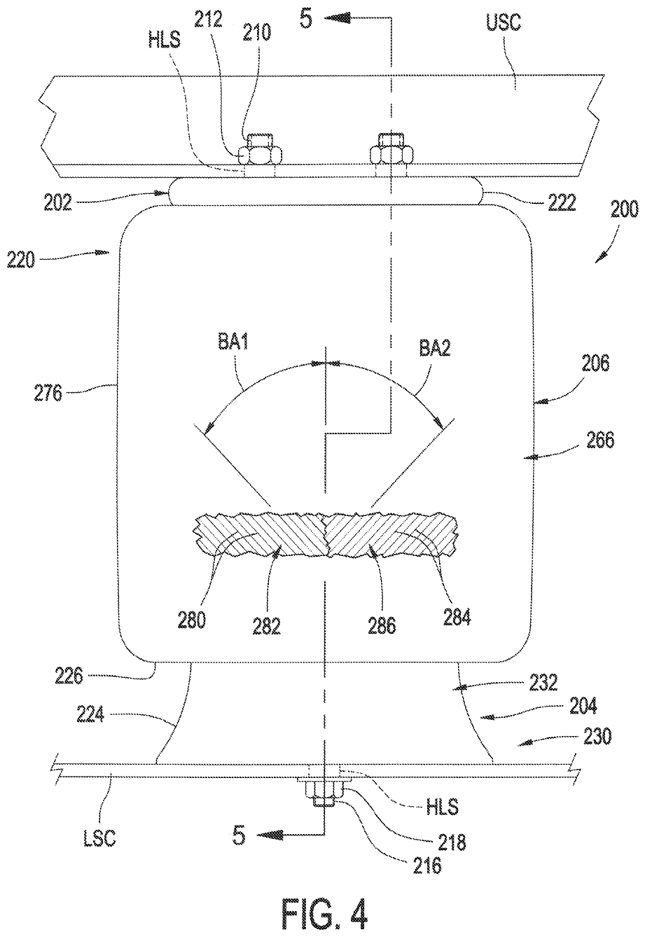

Having described an example of a suspension system (e.g., suspension system 100) capable of undergoing travel or displacement sufficient to generate a high-angular impact of a jounce bumper in accordance with the subject matter of the present disclosure, such as is represented in FIGS. 3, 7 and 8, for example, one example of a gas spring assembly 200 that is operable as gas spring assemblies 124 and/or 138, and constructed to withstand such conditions of use is shown and described in connection with at least FIGS. 4-9. As such, in accordance with the subject matter of the present disclosure, gas spring assembly 200, such as may be suitable for use as one of gas spring assemblies 124 and/or 138 in FIGS. 1-3, for example, can have a longitudinally-extending axis AX (FIG. 5). Gas spring assembly 200 can include one or more end members, such as an end member (or end member assembly) 202 and an end member (or end member assembly) 204 that is spaced longitudinally from end member 202. A flexible spring member 206 can extend peripherally around axis AX and can be secured between the end members in a substantially fluid-tight manner such that a spring chamber 208 is at least partially defined therebetween.

Gas spring assembly 200 can be disposed between associated sprung and unsprung masses of an associated vehicle in any suitable manner. For example, one end member can be operatively connected to the associated sprung mass (e.g., frame 108 and/or 128) with the other end member disposed toward and operatively connected to the associated unsprung mass (e.g., suspension components 112, 114 and/or 132). In the arrangement shown in FIGS. 4-8, for example, end member 202 can be secured along a first or upper structural component USC, such as frame 108 and/or 128 in FIGS. 1-3, for example, and can be secured thereon in any suitable manner. Additionally, in the arrangement shown in FIGS. 4-8, for example, end member 204 can be secured on or along a second or lower structural component LSC, such as one of suspension components 112, 114 and/or 132 in FIGS. 1-3, for example.

It will be appreciated that end members 202 and 204 can be secured on or along a corresponding one of upper and lower structural components USC and LSC in any suitable manner. For example, one or more securement devices 210, such as mounting studs, for example, can be included along end member 202. In some cases, such one or more securement devices 210 (e.g., mounting studs) can project outwardly from end member 202 and can be secured thereon in a suitable manner, such as, for example, by way of a flowed-material joint (not shown) or a press-fit connection (not identified). Additionally, such one or more securement devices 210 can extend through mounting holes HLS in upper structural component USC and receive one or more securement devices 212 (e.g., threaded nuts) cooperatively engaged therewith, for example. As an alternative to one or more of the mounting studs, one or more threaded passages (e.g., blind passages and/or through passages) could be used in conjunction with a corresponding number of one or more threaded fasteners.

Additionally, a fluid communication passage 214 can optionally be provided to permit fluid communication with spring chamber 208, such as may be used for transferring pressurized gas into and/or out of the spring chamber, for example. In the exemplary embodiment shown, fluid communication passage 214 extends through at least one of securement devices 210 and is in fluid communication with spring chamber 208. It will be appreciated, however, that any other suitable fluid communication arrangement could alternately be used.

End member 204 can be secured along a second or lower structural component LSC, such as one of suspension components 112, 114 and/or 132 in FIGS. 1-3, for example, in any suitable manner. As one example, lower structural component LSC could include one or more mounting holes HLS extending therethrough. In such case, a securement device 216 (e.g., a threaded stud) could be operatively connected to end member 204 and/or another component of the gas spring assembly, and could extend through one of mounting holes HLS, such as to receive a corresponding securement device 218 (e.g., a threaded nut), for example.

It will be appreciated that the one or more end members can be of any suitable type, kind, construction and/or configuration, and can be operatively connected or otherwise secured to the flexible wall in any suitable manner. In the exemplary arrangement shown in FIGS. 2 and 3, for example, end member 202 is of a type commonly referred to as a bead plate that is secured to a first end 220 of flexible spring member 206, such as by crimping or otherwise deforming an outer peripheral portion 222 of end member 202 to form a substantially fluid-tight, crimped-edge connection with end 220 of flexible spring member 206.

End member 204 is shown in the exemplary arrangement in FIGS. 3-8 as being of a type commonly referred to as a piston (or a roll-off piston) that has an outer surface 224 that abuttingly engages flexible spring member 206 such that a rolling lobe 226 is formed therealong. As gas spring assembly 200 is displaced between extended and collapsed conditions, rolling lobe 226 can be displaced along outer surface 224 in an otherwise conventional manner.

As identified in FIG. 5, end member 204 extends generally between a first or upper end 228 and a second or lower end 230. End member 204 can be formed from any suitable material or combination of materials, and can include any suitable number of one or more components. For example, the end member could be formed from two or more metal parts that are secured together, such as by way of one or more securement devices and/or flowed-material joints, for example. As another example, end member 204 could be at least partially formed from a polymeric material, and can, optionally and in some cases, be molded or otherwise formed as a single, unitary body that includes one or more walls and/or wall portions. In the arrangement in FIGS. 3-8, for example, end member 204 is shown as including an end member wall 232 that includes an outer side wall (or side wall portion) 234 that extends peripherally about axis AX and generally longitudinally between ends 228 and 230. Outer side wall portion 234 can at least partially define or otherwise include at least a portion of outer surface 224.

End member 204 can also include an inner end wall (or wall portion) 236 that extends generally transverse to axis AX and can at least partially form a closed end of the end member. End wall portion 234 can include an inner edge (not numbered) that at least partially defines a hole or opening (not numbered) that can be dimensioned to permit a securement device, such as securement device 216 (e.g., threaded stud), for example, to extend therethrough. In some cases, inner end wall portion 236 can be directly connected to or otherwise extend directly from the outer side wall portion. End member 204 can also include an outer end wall (or end wall portion) 238 that is disposed between inner end wall portion 236 and outer side wall portion 234. In the arrangement shown in FIGS. 5-8, outer end wall portion 238 has a generally linear cross-sectional shape and is disposed at an acute angle relative to axis AX such that the outer end of wall portion forms an end surface (or end surface portion) 240 with an approximately frustoconical shape. It will be appreciated, however, that wall portions having other cross-sectional shapes and/or configurations could alternately be used. End member 204 can further include a shoulder wall (or shoulder wall portion) 242 that has a curved cross-sectional shape and transitions between outer side wall portion 234 and outer end wall portion 238. In such an arrangement, inner end wall portion 236 together with outer end wall portion 238 and/or shoulder wall portion 242 can at least partially define a recess 244 extending into end member 204 and dimensioned to receive at least a portion of an associated end closure, such as will be described in detail hereinafter.

In some cases, end member 204 can include one or more additional walls or wall portions, such as may provide added structure, support and/or rigidity to the end member. For example, end member 204 can include a central support wall (or wall portion) 246 extending peripherally about axis AX and axially from along inner end wall portion 236 in a direction toward end 230. End member 204 can include an outer cavity 248 formed between outer side wall portion 234 and central support wall portion 246 that extends into the end member from along end 230. End member 204 can also, optionally, include a plurality of support walls (or support wall portions) 250 disposed in peripherally-spaced relation to one another about axis AX. The plurality of support walls can separate outer cavity 248 into a plurality of chambers (not shown). End member 204 can also include a central cavity 252 that is at least partially defined by central support wall 246 and can be dimensioned to receive one or more securement features, such as securement device 216 (e.g., threaded stud), for example.

In accordance with the subject matter of the present disclosure, gas spring assembly 200 also includes a jounce bumper and end closure system or assembly 256 that is secured on or along end member 204. In a preferred arrangement, system 256 is operative to both at least partially retain a second end 258 of flexible spring member 206 on or along end 228 of end member 204 and inhibit direct contact between end members 202 and 204 during jounce conditions JNC. It will be appreciated that jounce bumper and end closure system 256 can be operatively secured on or along end member 204 in any suitable manner and through the use of any suitable combination of components and/or devices. As a non-limiting example, a retaining nut 260 is positioned on or along the end closure opposite end member 204. Retaining nut 260 can be threadably secured on or along securement device 216. In such an arrangement, the end closure can be drawn tight to end 228 of end member 204, such as by using a securement device 262 (e.g., a threaded nut), for example, to thereby secure the end closure as well as second end 258 of flexible spring member 206 on or along the end member. In some cases, retaining nut 260 can be a bumper mounting nut and include one or more features and/or dimensions suitable for receivingly engaging the jounce bumper and thereby retaining the jounce bumper on or along the end closure. As one non-limiting example, retaining nut 260 can include a bumper retainer groove or undercut 264 that extends radially inward into the retaining nut and is dimensioned to receive at least a portion of the jounce bumper therein. It is to be understood, however, that the arrangement shown and described is merely exemplary and that any other suitable construction and/or configuration can alternately be used.

Flexible spring member 206 can include a flexible wall 266 that can extend between first and second ends 220 and 258. As discussed above, it will be appreciated that end members 202 and 204 can be operatively connected to first and second ends 220 and 258 in any suitable manner. As such, flexible spring member 206 and flexible wall 266 thereof can include any suitable combination of one or more features on or along the first and/or second ends that may be suitable for facilitating such operative connections. As one non-limiting example, flexible spring member 206 can include a mounting bead 268 disposed along end 220. Mounting bead 268 can extend peripherally around end 220 and can, optionally, include a bead reinforcement element 270, such as an endless, annular wire, for example. During assembly, outer peripheral portion 222 of the end member can be controllably deformed (e.g., crimped, swaged, pressed) into abutting engagement with flexible wall 206 such that mounting bead 268 is at least partially captured by the outer peripheral portion to form a crimped-edge connection with end member 202. As another example, flexible spring member 206 can include a mounting bead 272 disposed along end 258. Mounting bead 272 can extend peripherally around end 258 and can, optionally, include a bead reinforcement element 274, such as an endless, annular wire, for example.

It will be appreciated that flexible spring member 206 and flexible wall 266 thereof can be formed in any suitable manner and from any suitable material or combination of materials, such as by using one or more fabric-reinforced, elastomeric plies or layers and/or one or more un-reinforced, elastomeric plies or layers, for example. Typically, one or more fabric-reinforced, elastomeric plies and one or more un-reinforced, elastomeric plies will be used together and formed from a common elastomeric material, such as a synthetic rubber, a natural rubber or a thermoplastic elastomer. In other cases, however, a combination of two or more different materials, two or more compounds of similar materials, or two or more grades of the same material could be used.

As shown in FIGS. 4-8, for example, flexible wall 266 can include an outer surface 276 and an inner surface 278 that can at least partially define spring chamber 208. Flexible wall 266 can include an outer or cover ply (not identified) that at least partially forms outer surface 276 and/or an inner or liner ply (not identified) that at least partially forms inner surface 278. In a preferred arrangement, flexible wall 266 can also include one or more reinforcing plies disposed between outer and inner surfaces 276 and 278. The one or more reinforcing plies can be of any suitable construction and/or configuration. For example, the one or more reinforcing plies can include one or more lengths of filament material that are at least partially embedded therein. It will be appreciated that the one or more lengths of filament material can be of any suitable type, kind and/or construction, such as monofilament polymeric strands, braided cotton yarn or bundled carbon fibers, for example. Furthermore, such one or more lengths of filament material could optionally be coated or otherwise treated, such as, for example, to improve adhesion with the adjacent plies or other surrounding material. For example, the filament material could be rubber coated, such that upon applying a layer of rubber over the filament material improved adhesion between the various layers could result during and/or after vulcanization, for example.

Additionally, it will be appreciated that the one or more lengths of filament material, if provided, can be oriented in any suitable manner. As one example, flexible wall 266 is shown in FIG. 4 as including a plurality of filament segments 280 of one reinforcing ply 282 disposed at one bias angle BA1 and a plurality of filament segments 284 of another reinforcing ply 286 disposed another bias angle BA2. It will be appreciated that any suitable bias angles can be used, such as bias angles within a range of from approximately 3 degrees to approximately 87 degrees, for example. In some cases, the filament segments can be disposed at approximately the same bias angle but oriented in the opposing direction, such as is represented in FIG. 4 by reference dimensions BA1 and BA2, for example.

Gas spring assembly 200 differs from conventional constructions at least in that jounce bumper and end closure system 256 is constructed to generate a combination of elastomeric material compliance and geometric rigidity sufficient to withstand operating conditions that include high-angle impacts and compressive loads, such as may be associated with suspension systems of certain types, kinds and/or constructions, such as have been described above, for example. As illustrated in at least FIGS. 3, 5-8 and 11-14, jounce bumper and end closure system 256 includes a jounce bumper 288 and an end closure 290 that cooperatively operated with one another to generate the desired performance characteristics of system 256, such as are described in additional detail hereinafter. It will be appreciated that, in some cases, system 256 could be used in applications in which an otherwise conventional use of an end closure to secure an end of a flexible spring member on or along an end member is not utilized. In such cases, end closure 290 may simply operate as a jounce bumper mounting member and could be considered to be and/or referred to as such without departing from the subject matter of the present disclosure.

Jounce bumper 288 includes a bumper body 292 that can be formed from any suitable material or combination of materials and can be of any suitable or appropriate size, shape, configuration and/or construction, such as may be cooperative with the corresponding geometry of end closure 290 for use in a particular application. For example, bumper body 292 can be formed from a thermoplastic elastomer, a natural rubber compound, a synthetic rubber compound, or any combination of these and/or other elastomeric materials. Bumper body 292 is shown as including end surfaces (or end surface portions) 294 and 296 that are spaced apart from one another in an axial direction. An outer side surface (or surface portion) 298 can extend peripherally around the jounce bumper body.

End closure 290 includes an end closure wall 300 that can be formed from any suitable material or combination of materials. In a preferred arrangement, end closure 290 and end closure wall 300 thereof are formed as a single, unitary component from a metal material, such as steel or aluminum, for example. It will be appreciated, however, that other configurations and/or constructions could alternately be used.

End closure wall 300 includes a base wall portion 302 that is approximately planar and includes an inner edge surface (or surface portion) 304 that at least partially defines a hole or opening (not numbered) extending through the base wall portion. The opening can be dimensioned to receive at least a portion of retaining nut 260. In such an arrangement, at least a portion of retaining nut 260, such as an annular projection thereof, for example, can extend into the opening, such as to position the retaining nut on or along end closure 290, for example. It will be appreciated that retaining nut 260 can be secured on or along end closure wall 300 in any suitable manner, such as by way of a flowed-material joint 306, for example. As such, retaining nut 260 can be dimensioned to receive and retain bumper body 292 on or along end closure 290 in an otherwise conventional manner. In such an arrangement, securement device 216 can extend through the opening in end closure wall 300 and operatively engage a retaining nut 260 to secure system 256 on or along inner and/or outer end wall portions 236 and/or 238 of end member 204, such as has been discussed above. It will be appreciated, however, that other configurations and/or arrangements can alternately be used without departing from the subject matter of the present disclosure.

In some cases, bumper body 292 can include a passage or recess (not numbered) extending into or through the bumper body that is dimensioned to receive at least a portion of retaining nut 260. Through such interengagement, the bumper body is retained on or along end closure 290. It will be appreciated that other suitable connection or combination of connections could alternately be used, such as, for example, by using any combination of any one or more of mechanical fasteners or interengaging features, an adhesive substance or joint, molding or overmolding processes, vulcanizing or other cured-material joint to permanently attach (i.e., inseparable without damage, destruction or material alteration of at least one of the component parts) bumper body 292 on or along end closure 290.

End closure 290 and end closure wall 300 thereof includes an outer wall portion 308 disposed radially outward of base wall portion 302 that extends toward an outer peripheral edge 310. Outer wall portion 308 can include a curved cross-sectional shape or profile that extends peripherally around end closure 290. In an installed condition, outer wall portion 308 can at least partially urge or otherwise retain mounting bead 268 of flexible wall 266 into sealing engagement with end member 204, such as on or along inner and/or outer end wall portions 236 and/or 238 thereof, for example. That is, in some cases, outer wall portion 308 can abuttingly engage mounting bead 268 to compress or otherwise urge the mounting bead toward and into sealing engagement with inner and/or outer end wall portions 236 and/or 238 such that mounting bead 268 is retained on or along inner and/or outer end wall portions 236 and/or 238.

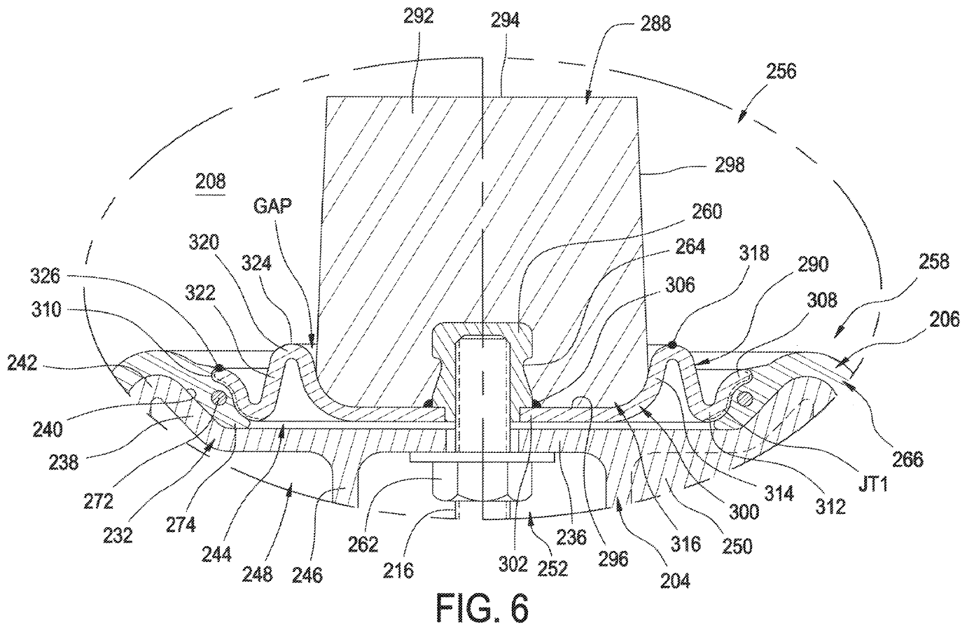

In some cases, end closure 290 can be permanently secured or otherwise attached to one or more components of the gas spring assembly. For example, a portion (e.g., mounting bead 268) of flexible spring member 206 can be adhered, vulcanized, cured or otherwise permanently attached (i.e., inseparable without damage, destruction or material alteration of at least one of the component parts) to end closure 290 or a surface or wall portion thereof (e.g., outer wall portion 308 and/or outer peripheral edge 310), such as is represented in FIG. 6 by dashed lines JT1, for example.

End closure wall 300 can also include an intermediate wall portion 312 disposed between base wall portion 302 and outer wall portion 308. Intermediate wall portion 312 can have a curved cross-sectional shape or profile oriented opposite the curved cross-sectional profile of outer wall portion 308. In such a configuration, intermediate wall portion 312 extends peripherally around end closure 290. Additionally, end closure wall 300 includes an inner side wall portion 314 disposed between base wall portion 302 and outer wall portion 308. Inner side wall portion 314 can extend between and operatively connect base wall portion 302 with intermediate wall portion 312. Inner side wall portion 314 is oriented to extend in a generally axial direction. It will be appreciated that inner side wall portion 314 can have any suitable combination of linear and/or curvilinear cross-sectional shapes or profiles cooperative with the elastomeric material properties, shape and/or construction of jounce bumper 288 operable to provide corresponding geometric rigidity and, thus, achieve the desired performance characteristics of jounce bumper and end closure system 256.

In a preferred configuration, inner side wall portion 314 can at least partially form a bumper-restraining recess 316 disposed radially inward of outer wall portion 308. In such cases, all or nearly all of bumper body 292 can be disposed radially inside bumper-restraining recess 316 of end closure 290. In such constructions, some of bumper body 292 will project from end closure 290 axially outward of bumper-restraining recess 316 beyond an axially-outermost extent 318 of end closure 290 such that end surface portion 294 and/or some of outer side surface portion 298 can abuttingly engage the opposing end member assembly or a component thereof (e.g., end member 202), particularly during high angular impacts and compressive loads of bumper body 292 associated with jounce conditions of the gas spring assembly, in accordance with the subject matter of the present disclosure.

As shown in FIGS. 5-9 and 11-14, outer side surface portion 298 can, as a non-limiting example, form a cylindrical or frustoconical outer shape or profile of bumper body 292. Inner side wall portion 314 can, as a non-limiting example, also have a cylindrical or frustoconical shape or profile. It will be appreciated that due at least in part to the configuration of inner side wall portion 314 and/or outer side surface 298 and the size, shape and/or orientation thereof relative to one another, an empty space or free volume exists within bumper-restraining recess 316 in an unloaded and undeflected condition of bumper body 292, such as is represented in FIG. 6 by reference dimension GAP.

It will be appreciated that the surfaces and/or walls of the bumper body and the end closure can have any suitable shape, profile and/or configuration cooperative with the elastomeric material properties and/or characteristics of jounce bumper 288 to provide corresponding progressive geometric rigidity to the jounce bumper and, thus, achieve the desired performance characteristics of system 256. As such, it will be recognized and understood that the combination of cylindrical and frustoconical side walls and/or surfaces shown and described herein are merely exemplary and not intended to be limiting. Thus, it will be further appreciated that any such corresponding free volume can be of any size, shape and/or configuration as may be suitable for providing system 256 with the desired progressive geometric rigidity in cooperation with the elastomeric material properties and/or characteristics of jounce bumper 288 to generate the desired performance characteristics for a given application, operation and/or use, such high angular impacts and compressive loads of jounce bumper 288 associated with jounce conditions of the gas spring assembly, in accordance with the subject matter of the present disclosure.

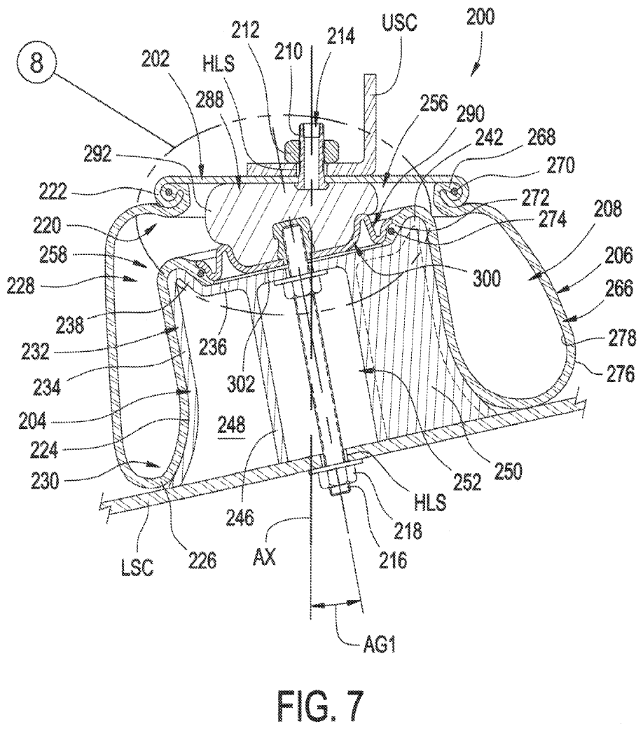

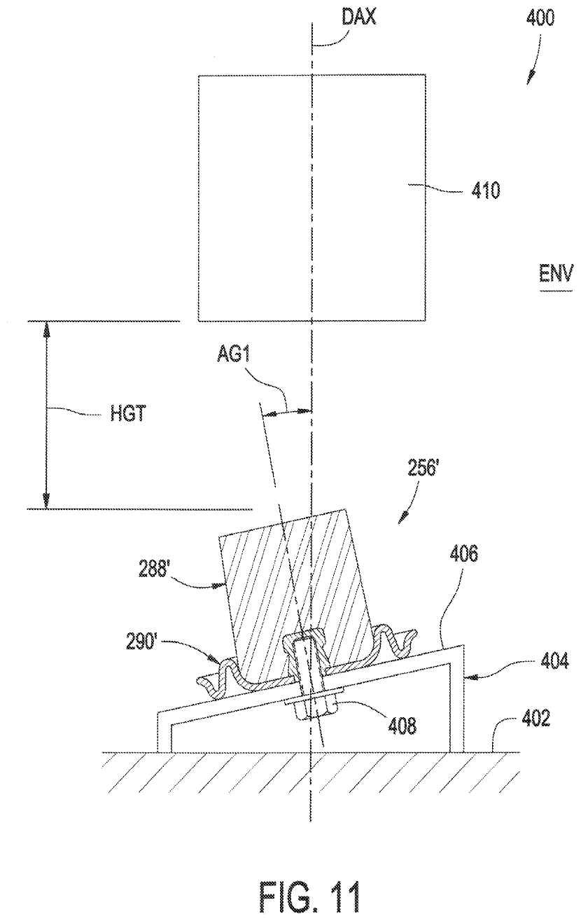

In many cases, otherwise conventional suspension systems can generate load conditions in jounce bumpers that are approximately axial or deviate from an axial direction by a relatively small amount, such as an angular deviation of up to about 5 degrees, for example. It will be appreciated that though non-axial load conditions induce both axial and lateral deflection in elastomeric jounce bumpers, non-axial load conditions occurring as such low angular deviations can generally be accommodated by the elastomeric material of the jounce bumpers as if the load condition was approximately axial. However, it has been recognized that as the angular deviation of the transient impact and quasistatic load condition increases, the ability of the elastomeric materials in conventional jounce bumpers decreases. As such, jounce bumper and end closure system 256 operates such that the elastomeric material compliance of the jounce bumper together with progressive engagement and corresponding rigidity generated by the end closure permits the elastomeric material of jounce bumper 288 to withstand transient impact and quasistatic loads at angular deviation of greater than seven (7) degrees and, in some cases, at angular deviation of greater than eleven (11) degrees. As such, as used herein, terms such as “high angular” and the like refer to angular deviation from the axial direction of at least five (5) degrees. In some cases, terms such as “high angular” and the like can refer to angular deviation from the axial direction of at least seven and one-half (7-½) degrees. In still other cases, terms such as “high angular” and the like can refer to angular deviation from the axial direction of at least eleven (11) degrees. Such angular deviation is represented in FIGS. 7 and 11 by reference dimension AG1.

To illustrate the use of jounce bumper and end closure system 256 in accordance with the subject matter of the present disclosure, bumper body 292 is shown in FIGS. 5, 6, 11 and 12 as being in a first, unloaded and undeflected condition. The jounce bumper can be deflected or displaced under high angular impacts and/or load conditions due to contact with any known components in any known configurations and/or arrangements, such as, for example, by having an opposing end member of a gas spring assembly, within which the jounce bumper assembly is disposed, contact the free end of the jounce bumper. The jounce bumper is then compressed or otherwise deflected in both an axial and lateral direction in response to relative movement of associated suspension components and/or other structural members on or between which the end members of the gas spring assembly are disposed. As the free end (e.g., end surface portion 294 and/or outer side surface portion 298 adjacent the end surface portion) of the bumper body is displaced through a given distance, corresponding lateral and radially outward displacement of the bumper body results, which displacement has a relation, at least in part, to the stress-strain properties of the elastomeric material forming the jounce bumper.

In the exemplary representations in FIGS. 7, 8, 13 and 14, a second condition of bumper body 292 is shown, which second condition is associated with the jounce bumper being displaced under high angular impacts and/or load conditions in accordance with the subject matter of the present disclosure. It will be recognized from the deformation of the jounce bumper represented in FIGS. 7, 8, 13 and 14 that the lateral deflection and radially outward displacement of the jounce bumper is at least partially constrained by inner side wall portion 314 of end closure wall 300, which resists lateral deflection and radially outward expansion of at least a portion of the bumper body. As such, FIGS. 7, 8, 13 and 14 illustrate representative deformation of bumper body 292 as substantially filling or otherwise reducing the size or amount of the free volume between the bumper body and the inner side wall portion (e.g., gap GAP within bumper-restraining recess 316).

In some cases, such as is shown in at least FIGS. 7, 8, 13 and 14, for example, jounce conditions associated with high angular impacts and/or loads can generate non-uniform deflections and/or deformations radially around jounce bumper 288. For example, illustrates one shape or profile of deflection along one side of bumper body 292, as is represented by reference characters PF1, and another, different shape or profile of deflection along the opposite side of bumper body 292, as is represented by reference characters PF2. It will be appreciated that in such high angular conditions of use, bumper body 292 can extrude outwardly beyond inner side wall portion and along a distal side wall portion 320 of end closure wall 300, which distal side wall portion 320 at least partially defines axially-outermost extent 318. In a preferred arrangement, distal side wall portion 320 has a curved profile or shape that transitions from inner side wall portion 314 to an outer side wall portion 322. In such a preferred arrangement, the curved profile or shape of distal side wall portion 320 provides a smooth, continuous exposed surface portion 324 on, along and/or otherwise across which bumper body 292 can be extruded or otherwise deformed during such conditions of use, such as to minimize or at least reduce the possibility of end closure 290 severing or otherwise rupturing bumper body 292.

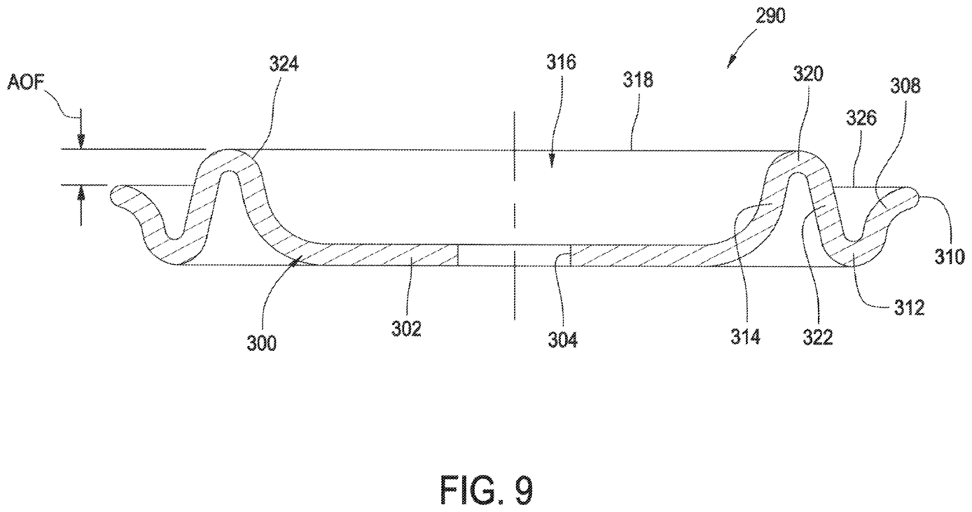

As shown in FIGS. 6 and 9, end closure 290 can be configured to include an edge distal extent 326 on or along outer peripheral edge 310 of outer wall portion 308. Edge distal extent 326 is axially offset from base wall portion 302 of end closure wall 300. Inner side wall portion 314 extends axially away from base wall portion 302 such that the combination of the inner side wall portion together with distal side wall portion 320 generates an axial depth of bumper-restraining recess 316 from base wall portion 302 to axial-outermost extent 318. In such cases, axially-outermost extent 318 is spaced axially offset from base wall portion 302 a greater distance than edge distal extent 326 is from base wall portion 302, such that an axial offset dimension AOF is disposed between the edge distal extent and axially-outermost extent of distal side wall portion 320. In a preferred construction, axial offset dimension AOF represent a condition in which axially-outermost extent 318 is axially offset from the base wall portion a distance that is at least thirty (30) percent greater than the distance that edge distal extent 326 is axially offset from the base wall portion. In a more-preferred construction, axial offset dimension AOF can represent a condition in which axially-outermost extent 318 is axially offset from the base wall portion a distance that is at least fifty (50) percent greater than the distance that edge distal extent 326 is axially offset from the base wall portion.

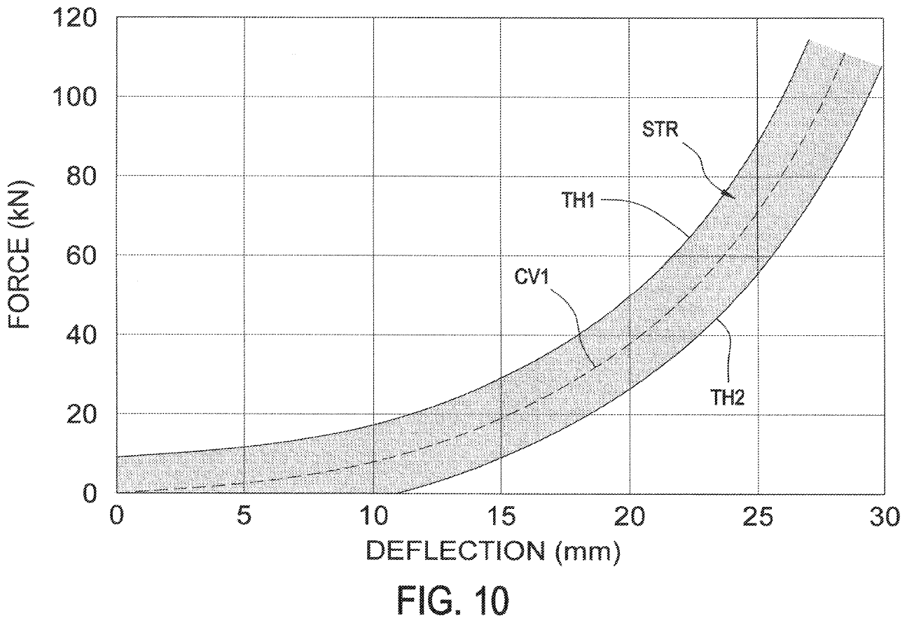

FIG. 10 is a graphical representation of force verses deflection and includes a stiffness curve CV1. FIG. 10 also includes a stiffness region STR bounded by a first or upper threshold stiffness curve TH1 and a second or lower threshold stiffness curve TH2. Threshold stiffness curves TH1 and TH2 are represented of so-called parallel or offset curves that are based on stiffness curve CV1. Stiffness curve CV1 is approximated by the third-order polynomial equation:

y=6.214x³−77.912x²+951.95x

It will be appreciated that jounce bumper and end closure system 256 having stiffness value within stiffness range STR and/or represented by stiffness curve CV1 due a combination of elastomeric material compliance of jounce bumper 288 and progressive geometric rigidity due to the configuration and arrangement of end closure 290 can withstand high-angle impacts and compressive loads, such as have been discussed herein in detail.

FIG. 11 is schematic representation of exemplary arrangement 400 for simulating high-angle impact conditions experienced by a jounce bumper and end closure system in accordance with the subject matter of the present disclosure. It will be appreciated that an arrangement can be suitable for use in assessing the capability of a proposed combination of an elastomeric material property of the jounce bumper and the proposed configuration and corresponding progressive geometric rigidity of an end closure to generate the desired performance characteristics for a given application, operation and/or use in connection with high angular impacts and compressive loads associated with jounce conditions of the gas spring assembly.

Arrangement 400 in FIGS. 11-14 as including a fixed base 402 with a support 404 secured thereto. Support 404 includes a mounting surface 406 disposed at an included angle representing angular deviation AG1. In accordance with the subject matter of the present disclosure, a proposed jounce bumper and end closure assembly 256′ can be secured on or along mounting surface 406 in a suitable manner, such as by way of securement device 408 threadably engaging proposed end closure 290′, for example. A striker body 410 is supported at a height above proposed jounce bumper 288′, such as is represented in FIG. 11 by height dimension HGT, for example. Striker body 410 is constructed to have a predetermined, desired mass and can be supported or otherwise guided to drop vertically along drop axis DAX on proposed assembly 256′ and impart a predetermined impact energy into proposed jounce bumper 288′. In this manner, the suitability of the proposed jounce bumper and end closure system can be assessed.

As discussed above, angular deviation AG1 can include a value within a range of from approximately five (5) degrees to approximately eleven (11) degrees or greater. For example, an angular deviation AG1 of approximately eleven and one half (11-½) degrees could be used in some cases. Additionally, in some cases, striker body 410 can be constructed to impart at least 1000 J of energy into proposed jounce bumper 288′. As a non-limiting example, striker body 410 could have a mass of approximately 130 kg dropped from a height of approximate 0.85 m. In some cases, evaluations can be performed under environmental conditions that include very low temperatures, such as at temperatures of −30 degrees Celsius or lower, such as is represented in FIG. 11 by reference characters ENV, for example.

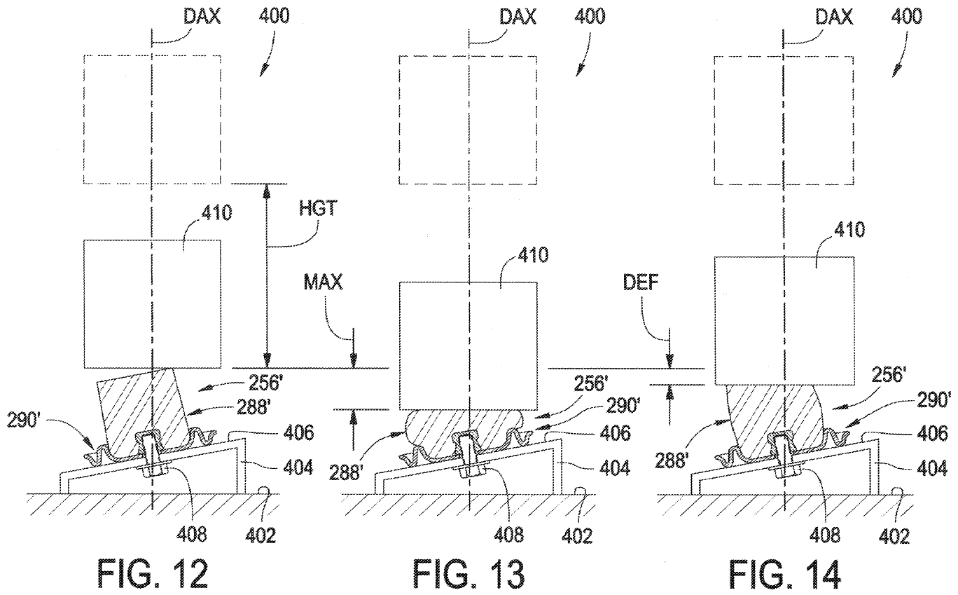

FIGS. 12-14 sequentially illustrate proposed jounce bumper and end closure system 256′ undergoing impact and deflection events, such as may aid in evaluating the suitability of the proposed system for use in connection with high angular impacts and compressive loads associated with jounce conditions. FIG. 12 represents the moment striker body 410 contacts proposed jounce bumper 288′. At that point, the amount of energy in striker body 410 is equal to the mass multiplied by drop height HGT multiplied by the acceleration due to gravity. FIG. 13 represents the moment of maximum compression of proposed jounce bumper 288′ within proposed end closure 290′, such as is represented by reference dimension MAX, for example. At this moment, striker body 410 has transferred an amount of energy equal to the mass multiplied by the acceleration due to gravity by the distance of drop height HGT plus deflection MAX. FIG. 14 represents the conclusion of the impact and deflection event. Proposed system 256′ has returned some amount of energy back into striker body 410 with proposed jounce bumper 288′ experiencing some permanent deformation, such as is represented by reference dimension DEF.

In use, a jounce bumper assembly in accordance with the subject matter of the present disclosure can provide one or more desired performance characteristics. For example, such a jounce bumper assembly can provide resistance to impact fatigue (i.e., provide the capability to withstand repeated impact loads) under the relatively high load conditions associated with heavy duty applications. A jounce bumper assembly in accordance with the subject matter of the present disclosure can also provide the capability to tune the performance characteristics (e.g., spring rate and deflection) of the jounce bumper assembly by using differently shaped bumper and inner side wall combinations to form different free volume configurations therebetween. The subject jounce bumper assembly can also achieve deflection, load carrying and other performance capabilities between those capabilities commonly provided by jounce bumpers formed from compliant materials (e.g., rubber and elastomeric foams) and those capabilities commonly associated with jounce bumpers formed from more rigid materials (e.g., fiber-reinforced and other high-strength plastics). Additionally, jounce bumper assemblies in accordance with the subject matter of the present disclosure may provide enhanced ride quality by permitting compliance during initial jounce travel of the suspension system while stiffening sufficiently during further jounce travel to minimize bump-through of road or other inputs. Furthermore, a jounce bumper assembly in accordance with the subject matter of the present disclosure can be capable of withstanding the loads associated with, and thereby functioning as a dock stabilizer for the loading and unloading of a vehicle.

It will be recognized that a jounce bumper assembly in accordance with the subject matter of the present disclosure would be expected to provide an initially compliant performance characteristic that is similar to that of a known compliant jounce bumper. Upon further deflection, however, as the outer side surface of the jounce bumper body increasingly engages the side wall portion of the end closure, the jounce bumper would begin to become increasingly stiff (i.e., to have less additional deflection at a given load) as the bumper body increasingly engages the inner side wall of the end closure and begins filling the free volume of the bumper-restraining recess, in comparison to a known jounce bumper that is formed from a similarly compliant material but which is radially unrestrained. That is, upon such deflection, the subject jounce bumper and end closure assembly provides substantially greater stiffness than such a known compliant (i.e., elastomeric) jounce bumper yet remain more compliant and capable of withstanding transient impacts than a known rigid jounce bumper. Additionally, it is expected that the subject jounce bumper assembly would be capable of withstanding quasistatic loads comparable to those subjected to known rigid jounce bumpers.

It should be understood that the deformations of the jounce bumper shown in FIGS. 3, 7, 8, 13 and 14 are provided merely as illustrations for presenting the foregoing discussion and, further, it should be recognized that such deformations are not to scale and are not intended to represent actual deformation conditions, which will vary from embodiment-to-embodiment depending, for example, upon the construction, configuration and properties of the materials used as well as upon other possible factors.

As used herein with reference to certain features, elements, components and/or structures, numerical ordinals (e.g., first, second, third, fourth, etc.) may be used to denote different singles of a plurality or otherwise identify certain features, elements, components and/or structures, and do not imply any order or sequence unless specifically defined by the claim language. Additionally, the terms “transverse,” and the like, are to be broadly interpreted. As such, the terms “transverse,” and the like, can include a wide range of relative angular orientations that include, but are not limited to, an approximately perpendicular angular orientation. Also, the terms “circumferential,” “circumferentially,” and the like, are to be broadly interpreted and can include, but are not limited to circular shapes and/or configurations. In this regard, the terms “circumferential,” “circumferentially,” and the like, can be synonymous with terms such as “peripheral,” “peripherally,” and the like.

It is to be recognized and appreciated that terms such as “can”, “may”, “might” and the like are to be interpreted as being permissive rather than required. As such, any reference to items with which terms such as “can”, “may”, “might” and the like are used shall be interpreted as being optional rather than required by the subject matter of the present disclosure unless otherwise specifically set forth herein.

Furthermore, the phrase “flowed-material joint” and the like, if used herein, are to be interpreted to include any joint or connection in which a liquid or otherwise flowable material (e.g., a melted metal or combination of melted metals) is deposited or otherwise presented between adjacent component parts and operative to form a fixed and fluid-tight connection therebetween. Examples of processes that can be used to form such a flowed-material joint include, without limitation, welding processes, brazing processes and soldering processes. In such cases, one or more metal materials and/or alloys can be used to form such a flowed-material joint, in addition to any material from the component parts themselves. Another example of a process that can be used to form a flowed-material joint includes applying, depositing or otherwise presenting an adhesive between adjacent component parts that is operative to form a fixed and fluid-tight connection therebetween. In such case, it will be appreciated that any suitable adhesive material or combination of materials can be used, such as one-part and/or two-part epoxies, for example.

Further still, the term “gas” is used herein to broadly refer to any gaseous or vaporous fluid. Most commonly, air is used as the working medium of gas spring devices, such as those described herein, as well as suspension systems and other components thereof. However, it will be understood that any suitable gaseous fluid could alternately be used.

It will be recognized that numerous different features and/or components are presented in the embodiments shown and described herein, and that no one embodiment may be specifically shown and described as including all such features and components. As such, it is to be understood that the subject matter of the present disclosure is intended to encompass any and all combinations of the different features and components that are shown and described herein, and, without limitation, that any suitable arrangement of features and components, in any combination, can be used. Thus it is to be distinctly understood claims directed to any such combination of features and/or components, whether or not specifically embodied herein, are intended to find support in the present disclosure. To aid the Patent Office and any readers of this application and any resulting patent in interpreting the claims appended hereto, Applicant does not intend any of the appended claims or any claim elements to invoke 35 U.S.C. 112(f) unless the words “means for” or “step for” are explicitly used in the particular claim.

Thus, while the subject matter of the present disclosure has been described with reference to the foregoing embodiments and considerable emphasis has been placed herein on the structures and structural interrelationships between the component parts of the embodiments disclosed, it will be appreciated that other embodiments can be made and that many changes can be made in the embodiments illustrated and described without departing from the principles hereof. Obviously, modifications and alterations will occur to others upon reading and understanding the preceding detailed description. Accordingly, it is to be distinctly understood that the foregoing descriptive matter is to be interpreted merely as illustrative of the subject matter of the present disclosure and not as a limitation. As such, it is intended that the subject matter of the present disclosure be construed as including all such modifications and alterations.

1. A jounce bumper and end closure system comprising:
a jounce bumper at least partially formed from elastomeric material, said jounce bumper having a longitudinal axis and including a first end surface portion oriented transverse to said longitudinal axis, a second end surface portion facing opposite said first end surface portion, and an outer peripheral side surface portion extending peripherally around said longitudinal axis between said first and second end surface portions; and,
an end closure including an end closure wall, said end closure wall including a base wall portion oriented transverse to said longitudinal axis and an inner side wall portion extending axially from along said base wall portion, said base wall portion and said inner side wall portion at least partially defining a bumper receiving recess dimensioned to receive at least said first end surface portion against said base wall portion with said second end surface portion projecting axially beyond said end closure wall, said outer peripheral side surface portion of said jounce bumper disposed in facing relation to said inner side wall portion of said end closure;
upon compression of said jounce bumper from along said second end surface portion toward said base wall portion, said inner side wall portion of said end closure generates progressive geometric rigidity within said jounce bumper.

2. A jounce bumper and end closure system comprising:
a jounce bumper at least partially formed from elastomeric material, said jounce bumper having a longitudinal axis and including a first end surface portion oriented transverse to said longitudinal axis, a second end surface portion facing opposite said first end surface portion, and an outer peripheral side surface portion extending peripherally around said longitudinal axis between said first and second end surface portions; and,
an end closure including an end closure wall, said end closure wall including a base wall portion oriented transverse to said longitudinal axis and an inner side wall portion extending axially from along said base wall portion, said base wall portion and said inner side wall portion at least partially defining a bumper receiving recess dimensioned to receive at least said first end surface portion against said base wall portion with said second end surface portion projecting axially beyond said end closure wall, said outer peripheral side surface portion of said jounce bumper disposed in facing relation to said inner side wall portion of said end closure;
said jounce bumper capable of withstanding a transient impact of at least 1000 J at an angular articulation of at least 5 degrees while simultaneously exhibiting a quasistatic load capacity of at least 1000 kN at 30 mm of axial deflection due to a combination of compliance of said elastomeric material of said jounce bumper and progressive geometric rigidity within said jounce bumper generated by said inner side wall portion of said end closure.

3. A jounce bumper and end closure system according to claim 1, wherein said end closure wall includes said base wall portion unitarily formed with said inner side wall portion.

4. A jounce bumper and end closure system according to claim 1, wherein said base wall portion is approximately planar.

5. A jounce bumper and end closure system according to claim 1, wherein said outer peripheral surface of said jounce bumper body is spaced radially inward of said inner side wall portion of said end closure in an uncompressed condition of said jounce bumper, and said outer peripheral surface of said jounce bumper is displaced into abutting engagement with said inner side wall portion upon compression of said jounce bumper from along said second end surface portion toward said base wall portion, said inner side wall portion of said end closure generates progressive geometric rigidity within said jounce bumper.

6. A jounce bumper and end closure system according to claim 1, wherein said inner side wall portion has a cross-sectional profile extending peripherally around said longitudinal axis such that said inner side wall portion has one of a curvilinear shape, a frustoconical shape and a cylindrical shape.

7. A jounce bumper and end closure system according to claim 1, wherein said end closure includes an outer peripheral wall portion disposed radially outward of said inner side wall portion.

8. A jounce bumper and end closure system according to claim 7, wherein said end closure wall includes an intermediate wall portion extending radially between and operatively interconnecting said inner side wall portion and said outer peripheral wall portion.

9. A jounce bumper and end closure system according to claim 1, wherein said jounce bumper extends radially outward beyond said inner side wall portion of said end closure in a compressed condition of said jounce bumper.

10. A jounce bumper and end closure system according to any one of claim 1, wherein said end closure includes a distal side wall portion that at least partially defines an axially-outermost extent of said end closure opposite said base wall portion, said distal side wall portion having curved profile that extends radially outward beyond said inner side wall portion and provides a smooth, continuous exposed surface portion along which said jounce bumper is deformed in a compressed condition.

11. A jounce bumper and end closure system according to any one of claim 1, wherein said jounce bumper exhibits compressive stiffness profile at least partially generated by a combination of compliance of said elastomeric material of said jounce bumper and progressive geometric rigidity within said jounce bumper generated by said inner side wall portion of said end closure.

12. A jounce bumper and end closure system according to claim 1, wherein said jounce bumper exhibits compressive stiffness profile along a stiffness curve approximated by the third-order polynomial equation:
y=6.214x³−77.912x²+951.95x

13. A jounce bumper and end closure system according to claim 1, wherein said jounce bumper exhibits compressive stiffness profile falling within a stiffness region bounded by a first threshold stiffness curve offset in a first direction from a base stiffness curve and a second threshold stiffness curve offset in a second direction from said base stiffness curve with said base stiffness curve approximated by the third-order polynomial equation:
y=6.214x³−77.912x²+951.95x

14. A gas spring assembly comprising:
a flexible spring member having a longitudinal axis and extending peripherally about said longitudinal axis between a first end and a second end spaced longitudinally from said first end, said flexible spring member at least partially defining a spring chamber;
a first end member secured across said first end of said flexible spring member;
a second end member secured across said second end of said flexible spring member; and,
a jounce bumper and end closure system according claim 1 disposed within the spring chamber and secured on or along one of the first and second end members.

15. (canceled)

16. A jounce bumper and end closure system according to claim 1, wherein said jounce bumper withstands transient impacts of at least 1000 J at an angular articulation of at least 5 degrees while simultaneously exhibiting a quasistatic load capacity of at least 1000 kN at 30 mm of axial deflection due to a combination of compliance of said elastomeric material of said jounce bumper and said progressive geometric rigidity within said jounce bumper generated by said inner side wall portion of said end closure.

17. A jounce bumper and end closure system according to claim 2, wherein said outer peripheral surface of said jounce bumper body is spaced radially inward of said inner side wall portion of said end closure in an uncompressed condition of said jounce bumper, and said outer peripheral surface of said jounce bumper is displaced into abutting engagement with said inner side wall portion upon compression of said jounce bumper from along said second end surface portion toward said base wall portion, said inner side wall portion of said end closure generates progressive geometric rigidity within said jounce bumper.

18. A jounce bumper and end closure system according to claim 2, wherein said end closure wall includes an outer peripheral wall portion disposed radially outward of said inner side wall portion and an intermediate wall portion extending radially between and operatively interconnecting said inner side wall portion and said outer peripheral wall portion.

19. A jounce bumper and end closure system according to claim 2, wherein said end closure includes a distal side wall portion that at least partially defines an axially-outermost extent of said end closure opposite said base wall portion, said distal side wall portion having curved profile that extends radially outward beyond said inner side wall portion and provides a smooth, continuous exposed surface portion along which said jounce bumper is deformed in a compressed condition

20. A jounce bumper and end closure system according to claim 2, wherein said jounce bumper exhibits compressive stiffness profile along a stiffness curve approximated by the third-order polynomial equation:
y=6.214x³−77.912x²+951.95x

21. A jounce bumper and end closure system according to claim 2, wherein said jounce bumper exhibits compressive stiffness profile falling within a stiffness region bounded by a first threshold stiffness curve offset in a first direction from a base stiffness curve and a second threshold stiffness curve offset in a second direction from said base stiffness curve with said base stiffness curve approximated by the third-order polynomial equation:
y=6.214x³−77.912x²+951.95x
